(19) United States
(12) Patent Application Publication
(10) Pub. No.: US 2013/0242073 A1
(43) Pub. Date: Sep. 19, 2013

(54) IMAGE-CAPTURING CONTROL APPARATUS AND CONTROL METHOD OF CAPTURING IMAGE

(71) Applicant: DENSO CORPORATION, Kariya-city (JP)

(72) Inventor: Taito WATANABE, Obu-city (JP)

(73) Assignee: DENSO CORPORATION, Kariya-city (JP)

(21) Appl. No.: 13/826,822

(22) Filed: Mar. 14, 2013

(30) Foreign Application Priority Data
Mar. 19, 2012 (JP) 2012-62349

(51) Int. Cl. H04N 5/235

(52) U.S. Cl. CPC H04N 5/2351
USPC 348/77

(57) ABSTRACT

An image-capturing control apparatus includes a storage device, a calculation section, an obtaining section, and a compensating section. The storage device stores prepared relation data of prepared images of a target. Each prepared relation data indicates a relationship between information of a prepared luminance non-uniformity in corresponding one of the prepared images and a prepared capture distance. The calculation section calculates a current capture distance when a current image of the target is captured. The obtaining section obtains information of a target luminance non-uniformity from one of the prepared relation data when the current capture distance is equal to the prepared capture distance. The compensating section compensates a current luminance non-uniformity in the current image based on the information of the target luminance non-uniformity.

### CROSS REFERENCE TO RELATED APPLICATION

This application is based on Japanese Patent Application No. 2012-062349 filed on Mar. 19, 2012, the disclosure of which is incorporated herein by reference.

### TECHNICAL FIELD

The present disclosure relates to an image-capturing control apparatus that controls capturing an image of a target, such as a face of a driver, and a control method of capturing an image of the target.

### BACKGROUND

Conventionally, an identification of an individual, such as a driver, is performed by capturing images of a face of the individual and analyzing the images as disclosed in JP 2006-277688 A, JP 2001-331795 A, JP 2005-323180 A, JP 2002-15311 A, and JP 2005-316743 A.

Further, as disclosed in JP 2009-96323 A, a detection of a state of a driver is performed by capturing images of a face of the driver and analyzing the images in order to detect the state of the driver that may abnormally affect driving of a vehicle. The state that may abnormally affect driving of the vehicle may be a drowsy state of the driver and an inattentive state of the driver.

In above-described technologies, when capturing images at a nighttime, in order to capture stabilized images, a light source, such as an illuminator, is provided to emit necessary amount of light, such as near infrared light, toward the face and around the face of the driver.

When the illuminator emits the light toward, for example, the face of the driver at the nighttime, luminances of a face area of the driver differ from unit area to unit area within the face area. That is the face area of the driver has luminance variation, which is also known as luminance non-uniformity. Accordingly, an image of the face of the driver has luminance non-uniformity.

Usually, a surface of the face of the driver is not flat. Thus, a distance from the illuminator to each point on the surface of the face may be different. For example, a distance from the illuminator to a nose is different from a distance from the illuminator to a cheek. Further, an intensity of the light emitted from the illuminator is inversely proportional to the square of the distance from the illuminator to the point on the face. Thus, a luminance of each point on the surface of the face is different from point to point. Accordingly, the face area has the luminance non-uniformity as described above.

The luminance non-uniformity on the face area changes with the distance from the illuminator to the face and a distance from the camera to the face. Thus, when a position of the face of the driver changes, the luminance non-uniformity on the face area changes, accordingly. When the luminance non-uniformity is generated on the face of the driver, the image of the face of the driver may also have the luminance non-uniformity. Thus, an identification accuracy of identifying the individual based on the image having the luminance non-uniformity is degraded, and a detection accuracy of detecting the state of the driver based on the image having the luminance non-uniformity is degraded.

To increase the identification accuracy and the detection accuracy, the light emitted from the light source needs to be controlled so that the face of the driver is uniformly illuminated by the light. However, the driver usually moves the face from front to back and from side to side. Thus, controlling the light to be illuminated uniformly on the face of the driver is difficult.

### SUMMARY

In view of the foregoing difficulties, it is an object of the present disclosure to provide an image-capturing control apparatus which restricts a luminance non-uniformity generated in an image of a target even when a position of the target changes. It is another object of the present disclosure to provide a control method of capturing an image of a target which restricts a luminance non-uniformity generated in the image of the target even when a position of the target changes.

According to an aspect of the present disclosure, an image-capturing control apparatus, which controls a light source to emit light including near infrared light toward a target and controls an image-capturing device to capture an image of the target, includes a storage device, a calculation section, an obtaining section, and a compensating section. The storage device stores a plurality of prepared relation data of a plurality of prepared images of the target. Each of the prepared relation data indicates a relationship between information of a prepared luminance non-uniformity in corresponding one of the prepared images and a prepared capture distance at which the corresponding one of the prepared images is captured. The calculation section calculates a current capture distance when the image-capturing device captures a current image of the target. The obtaining section obtains information of a target luminance non-uniformity from one of the prepared relation data when the current capture distance is equal to the prepared capture distance of the one of the prepared relation data. The target luminance non-uniformity is equal to the luminance non-uniformity of the one of the prepared relation data. The compensating section compensates a current luminance non-uniformity in the current image of the target based on the information of the target luminance non-uniformity.

In the above apparatus, a luminance non-uniformity generated in the current image of the target is reduced.

According to another aspect of the present disclosure, a control method of capturing an image of a target includes storing a plurality of prepared relation data of a plurality of prepared images of the target captured at a plurality of prepared capture distances, capturing a current image of the target, detecting a current capture distance at which the current image of the target is captured, obtaining a target luminance non-uniformity from one of the prepared relation data when the current capture distance is equal to the prepared capture distance of the one of the prepared relation data, and compensating a current luminance non-uniformity in the current image of the target based on the target luminance non-uniformity. Each of the prepared relation data indicates a relationship between a prepared luminance non-uniformity in corresponding one of the prepared images and a prepared capture distance at which the corresponding one of the prepared images is captured. The target luminance non-uniformity is the luminance non-uniformity of the one of the prepared relation data.

With the above method, a luminance non-uniformity generated in the current image of the target is reduced.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of a system in which an image-capturing control apparatus according to an embodiment of the present disclosure is applied;

FIG. 2 is a block diagram showing functional blocks of the image-capturing control apparatus according to the embodiment of the present disclosure;

FIG. 3A is a diagram showing a luminance distribution in a face image, and FIG. 3B is a diagram showing luminance distributions in face images, which changes with respect to a distance;

FIG. 4A is a diagram showing a luminance distribution in a face image that is divided into multiple micro regions when the face image is taken at a distance, and FIG. 4B is a diagram showing a luminance distribution in a face image that is divided into multiple micro regions when the face image is taken at a distance farther than the distance in FIG. 4A; and

FIG. 5 is a flowchart showing a control process executed by the image-capturing control apparatus according to the embodiment.

### DETAILED DESCRIPTION

The following will describe an embodiment of the present disclosure with reference to the drawings.

### First Embodiment

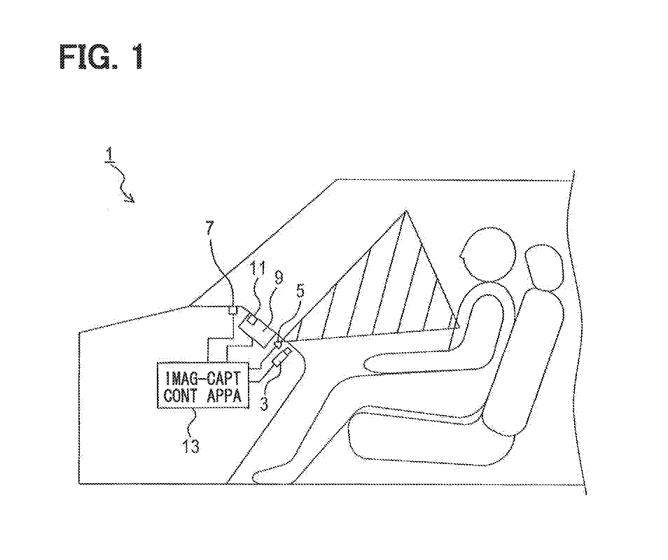

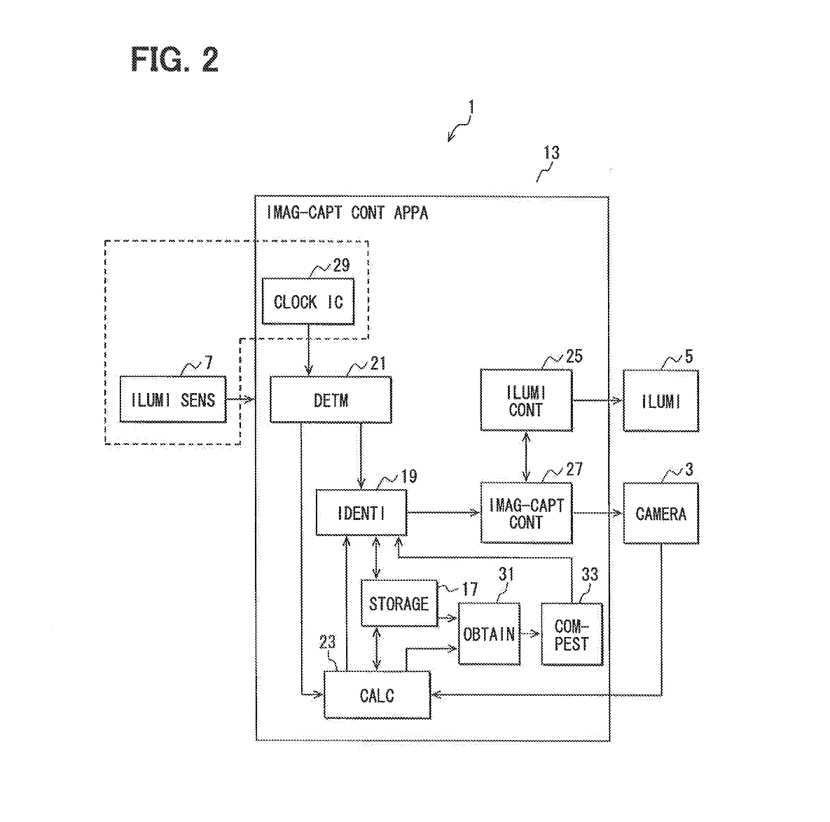

The following will describe a configuration of an in-vehicle system, which includes an image-capturing control apparatus (IMAG-CAPT CONT APPA) 13, with reference to FIG. 1 and FIG. 2. As shown in FIG. 1 and FIG. 2, an image-capturing apparatus 1 is placed in a vehicle to capture images of a face of a person who is in the vehicle, such as a driver. The image-capturing apparatus 1 further obtains, from the images, a gaze direction and an eye condition of the driver to detect a state of the driver and support driving of the vehicle based on the state of the driver. Herein, the gaze direction is determined based on a position of a pupil, and the eye condition refers to an open state or a closed state of at least one of eyes of the driver.

The image-capturing apparatus 1 includes a camera 3, an illuminator (ILUMI) 5, an illumination intensity sensor (ILUMI SENS) 7, a navigation device 9, a manipulation panel 11, and the image-capturing control apparatus 13. The camera 3 captures the images of the face of the driver. The illuminator 5, which is provided as one example of a light source, emits light toward the face of the driver during the camera 3 captures the images of the face of the driver. The light emitted from the illuminator 5 includes near infrared light. The illumination intensity sensor 7 detects a brightness of a surrounding area of the illumination intensity sensor 7.

The camera 3 includes a charge-coupled device (CCD) image sensor. As well known, the CCD image sensor is sensitive to near-infrared light, which allows an infrared photography. As shown in FIG. 1, the camera 3 is disposed, for example, near an instrument panel (not shown) of the vehicle so that the face of the driver is captured by the camera 3. The camera 3, such as the CCD camera, may operate as an image-capturing device.

The illuminator 5 may, for example, include near infrared light emitting diodes (LED). The illuminator 5 is disposed so that the face of the driver is illuminated by the near infrared light emitted from the illuminator 5. An illuminated space, which is illuminated by the light emitted from the illuminator 5, has a cone shape with the face of the driver positioned on an optical axis of the illuminator 5. The optical axis of the illuminator 5 is on an axis of the illuminated space having the cone shape.

The illuminator 5 is disposed near the camera 3 so that the optical axis of the illuminator 5 is approximately equal to an optical axis of the camera 3. Thus, a distance from the illuminator 5 to the face of the driver is approximately equal to a distance from the camera 3 to the face of the driver. Hereinafter, the distance from the illuminator 5 to the face of the driver is referred to as a first distance, and the distance from the camera 3 to the face of the driver is referred to as a second distance.

The illumination intensity sensor 7 is equipped to, for example, a dashboard of the vehicle. The illumination intensity sensor 7 detects the brightness of the surrounding area. More specifically, the illumination intensity sensor 7 is an environment light sensor that detects an intensity of environment light in the surrounding area. The illumination intensity sensor 7 detects a weak illumination state or a strong illumination state. In the weak illumination state, the intensity of the environment light is weak, that is, the surrounding area is dark, such as in the nighttime. In the strong illumination state, the intensity of the environment light is strong, that is, the surrounding area is bright, such as in the daytime.

The navigation device 9 specifies a current position of the vehicle on a map, performs a route guidance and the like. For example, the navigation device 9 may detect that the vehicle passes through a place at which the intensity of the environment light is weak, such as in a tunnel.

The manipulation panel 11 is provided by, for example, a switch, which is manipulatable. The driver may, for example, activate or deactivate an image-capturing control by manipulating the manipulation panel 11. Further, the driver may input control values used for the image-capturing control by manipulating the manipulation panel 11. The control values may include the intensity of the light emitted from the illuminator 5.

The image-capturing control apparatus 13 is an electronic control apparatus including a well-known microcomputer. The image-capturing control apparatus 13 controls an illumination state of the near infrared light emitted from the illuminator 5, an image-capturing state of the camera 3, and the like, based on image data of the images of the target obtained from the camera 3 and signals from the illumination intensity sensor 7. The illumination state of the illuminator 5 may include an intensity of the near infrared light emitted from the illuminator 5 and an illumination timing of the near infrared light. The image-capturing state of the camera 3 may include an exposure time and an analog gain of the camera 3.

As shown in FIG. 2, the image-capturing control apparatus 13 includes a storage device (STORAGE) 17, an identification section (IDENTI) 19, a determination section (DETM) 21, a calculation section (CALC) 23, an illuminator control section (ILUMI CONT) 25, an image-capturing control section (IMAG-CAPT CONT) 27, an obtaining section (OBTAIN) 31, and a compensating section (COMPEST) 33. Further, the image-capturing control apparatus 13 includes a clock integrated circuit (IC) 29, which outputs a real time (current time) to the determination section 21 based on a measured value.

The storage device 17 stores multiple data, which are necessary for a control operation of the image-capturing control apparatus 13. For example, the storage device 17 stores prepared relation data of prepared images of the face of driver. Each prepared relation data indicates a relationship between information of a prepared luminance non-uniformity in a corresponding prepared image and a prepared capture distance at which the corresponding prepared image is captured. Hereinafter, the face of the driver is referred to as the face, and the image of the face of the driver is referred to as a face image.

The identification section 19 identifies features of the face by processing and analyzing the image data obtained from the camera 3. For example, the identification section 19 specifies a face orientation and a gaze direction of the driver based on the position of the pupil. Further, the identification section 19 specifies the eye condition, which is in one of the open state and the closed state. Further, the identification section 19, based on the image data, determines the illumination state of the near infrared light emitted from the illuminator 5. Further, the identification section 19, based on the image data, determines whether the exposure time and the analog gain of the camera 3 are appropriate.

The determination section 21 determines whether the surrounding area is in the daytime or in the nighttime based on the current time transmitted from the clock IC 29 and the signal transmitted from the illumination intensity sensor 7. The signal transmitted from the illumination intensity sensor is indicative of the intensity of the environment light.

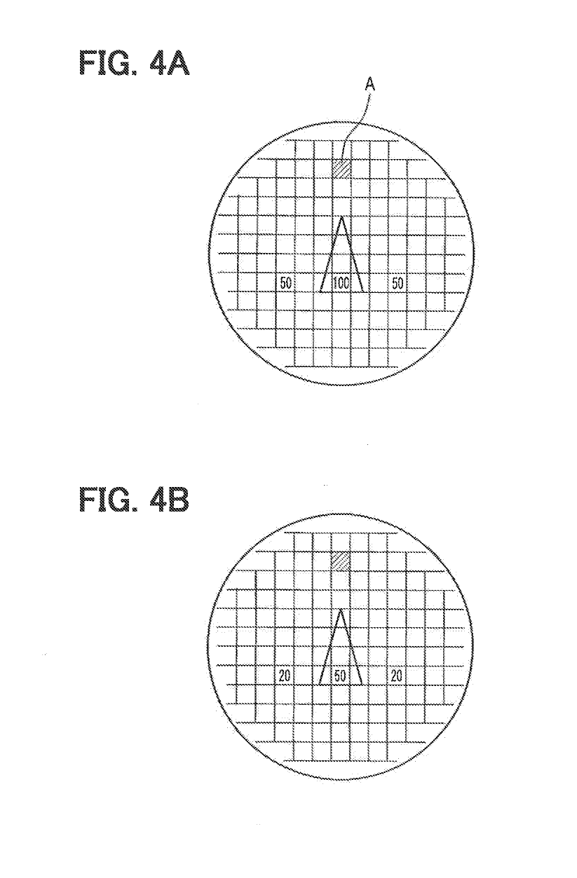

The calculation section 23 calculates the distance from the illuminator 5 to the face based on the image data of the face images obtained from the camera 3. In the face image, a luminance at a point of the face decreases with an increase of the distance from the illuminator 5 to the face. Thus, a distance from the illuminator 5 to the face may be estimated based on change of a luminance at a predetermined point in the face image, such as a forehead center A shown in FIG. 4A.

The illuminator control section 25 controls the illuminator 5 to emit the light in a predetermined pattern. The image-capturing control section 27 controls the camera 3 based on information obtained from the identification section 19 and control information of the illuminator 5, which is obtained from the illuminator control section 25. For example, the image-capturing control section 27 controls the exposure time of the camera 3. The information obtained from the identification section 19 includes luminance information of the face image and the like.

Each of the identification section 19, the determination section 21, the calculation section 23, the illuminator control section 25 and the image-capturing control section 27 is provided by a well-known microcomputer, which mainly includes a central processing unit (CPU). The storage device 17 may be provided by a non-volatile memory, such as an electrically erasable programmable read-only memory (EEPROM).

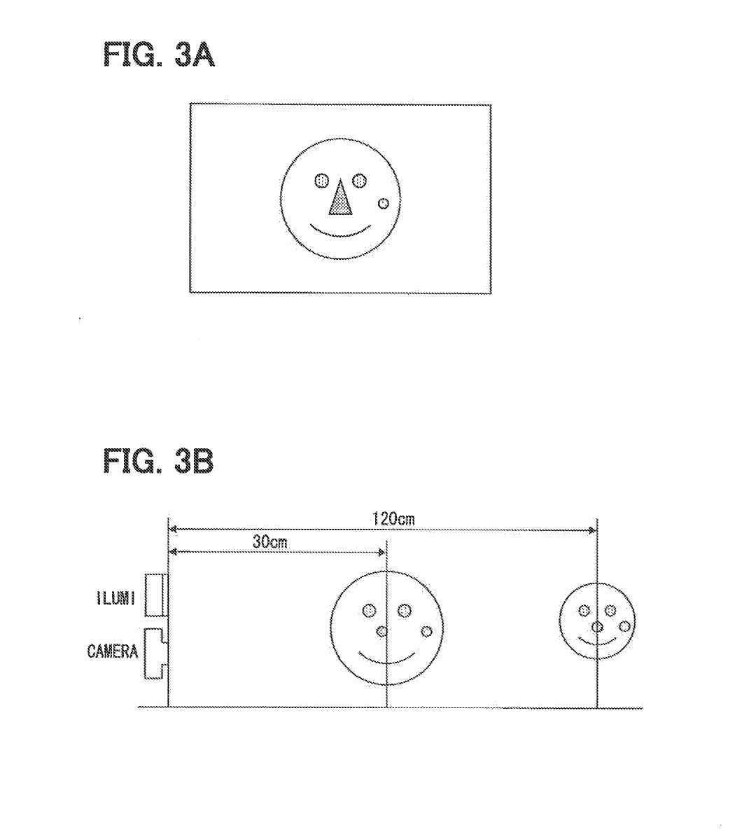

The following will describe a relationship between the distance from the illuminator 5 to the face and the luminance non-uniformity with reference to FIG. 3A to FIG. 4B. In the present embodiment, the distance from the illuminator 5 to the face, which is referred to as the first distance, is approximately equal to the distance from the camera 3 to the face, which is referred to as the second distance. Thus, in the following description, the distance at which the face image is captured signifies the first distance.

As shown in FIG. 3A, the surface of the face is uneven. Thus, when the illuminator 5 emits the near infrared light toward the face, the luminance of the face is non-uniform. Accordingly, when the camera 3 captures the face image, the luminance of the face image captured by the camera 3 is distributed in a non-uniform manner. That is, a luminance variation is generated on the face image caused by the uneven surface of the face.

For example, the distance from the illuminator 5 to the nose is different from the distance from the illuminator 5 to the cheek, which is placed on each of left and right side of the nose. Thus, the luminance of the face image at the nose is different from the luminance of the face image at the cheek compared with an ideal case in which the surface of the face is flat. Thus, the luminance non-uniformity is generated in the face image.

Further, as shown in FIG. 3B, the luminance non-uniformity in the face image changes with the distance from the illuminator 5 to the face. For example, the luminance non-uniformity generated in the face image in a case where the face is apart from the illuminator 5 by 30 centimeters is different from the luminance non-uniformity generated in the face image in a case where the face is apart from the illuminator 5 by 120 centimeters.

As described above, the intensity of the near infrared light emitted from the illuminator 5 is inversely proportional to the square of the distance from the face to the illuminator 5. Herein, a point at which the optical axis of the illuminator 5 passes through the surface of the face is referred to as a base point, and a point on the face other than the base point is referred to as a specific point. A relationship, between a distance from the illuminator 5 to the base point of the face and a distance from the base point to the specific point, changes with the distance from the illuminator 5 to the specific point of the face. Thus, the intensity of the near infrared light at the specific point of the face changes with the distance from the illuminator 5 to the specific point of the face. Thus, the luminance non-uniformity in the face image changes with the distance from the illuminator 5 to the specific point of the face. Generally, the luminance non-uniformity in the face image changes with the distance from the illuminator 5 to the face.

FIG. 4A and FIG. 4B shows a change of the luminance non-uniformity with respect to the distance. Further, in FIG. 4A and FIG. 4B, the face is divided into meshes, each of which is referred to as a micro region. In FIG. 4A and FIG. 4B, the meshes are divided so that each mesh (micro region) has a predetermined size. The face may also be divided into meshes so that each mesh corresponds to one pixel of the face image.

As shown in FIG. 4A, at the distance apart from the illuminator 5 by, for example, 30 centimeters, a micro region corresponding to a center of the face (lower center portion of the nose) has an average luminance value of 100, and micro regions corresponding to the cheeks positioned at each side of the nose respectively have average luminance values of 50.

As shown in FIG. 4B, at the distance apart from the illuminator 5 by, for example, 120 centimeters, a micro region corresponding to the center of the face has an average luminance value of 50, and micro regions corresponding to the cheeks respectively have average luminance values of 20.

As shown in FIG. 4A and FIG. 4B, the luminances at different portions of the face change with the distance from the illuminator 5 to the face. Additionally, a distribution of the luminances of the face changes with the distance from the illuminator 5 to the face.

For example, when the luminance on each portion of the face shown in FIG. 4B is doubled, the nose end has the luminance value of 100, which is equal to the luminance value of the nose end in FIG. 4A. However, luminance values of other parts, such as the cheeks, in FIG. 4B are not exactly equal to the luminance values of the corresponding portions in FIG. 4A even when the luminance on each portion of the face in FIG. 4B is doubled. This is because, the luminance non-uniformity is caused by the distance from the illuminator 5 to the face.

The image-capturing control apparatus 13 according to the present embodiment measures a distribution of the luminance of the face image at multiple prepared positions which are set apart from the illuminator 5 by prepared capture distances. Each of the prepared positions is apart from an adjacent prepared position by a predetermined distance interval, such as 1 centimeter. Then, the image-capturing control apparatus 13 compensates a currently captured face image, which is also referred to as a current image of the target, so that the face image has a constant luminance non-uniformity regardless of a current capture distance from the illuminator 5 to the face.

For example, when the face image shown in FIG. 4A is set as a reference prepared image, the image-capturing control apparatus 13 compensates the currently captured face image so that a luminance non-uniformity of the currently captured face image is equal to the luminance non-uniformity of the reference prepared image shown in FIG. 4A. Specifically, supposed that the face image shown in FIG. 4B is the currently captured face image, the image-capturing control apparatus 13 compensates the currently captured face image so that the luminance non-uniformity of the currently captured face image in FIG. 4B is equal to the luminance non-uniformity of the reference prepared image in FIG. 4A. Specifically, the image-capturing control apparatus 13 compensates the luminance non-uniformity of the currently captured face image in FIG. 4B so that a distribution of the luminance in FIG. 4B is equal to a distribution of the luminance in FIG. 4A, In the face image shown in FIG. 4A, a ratio of the luminance value at the center to the luminance value at the cheek is 100 to 50. Thus, the image-capturing control apparatus 13 compensates the face image in FIG. 4B so that the luminance at the center becomes 100 by increasing the luminance having the luminance value of 50 by two times and the luminance at the cheek becomes 50 by increasing the luminance having the luminance value of 20 by 2.5 times. Thus, the luminance non-uniformity in the face image, which is captured at the distance of 120 centimeters, is compensated to be equal to the luminance non-uniformity in the face image, which is captured at the distance of 30 centimeters.

The image-capturing control apparatus 13 preliminarily stores, in the storage device 17, the prepared relation data based on which the above described compensation is performed. For example, when the image-capturing control apparatus 13 compensates the currently captured face image, which is captured at the distance of 120 centimeters as shown in FIG. 4B, the image-capturing control apparatus 13 sets a compensation coefficient for each micro region in the prepared face image captured at the prepared capture distance with respect to the prepared reference image. The compensation coefficient is a conversion factor of the luminance at each micro region on the prepared face image with respect to the prepared reference image. In the prepared face image shown in FIG. 4B, the conversion factor at the cheek with respect to the reference prepared image is 2.5. Further, the image-capturing control apparatus 13 may set the compensation coefficient for each pixel in the prepared face image.

The image-capturing control apparatus 13 stores data of the compensation coefficient set for each micro region or each pixel in each prepared face image, which is captured at a corresponding prepared capture distance from the illuminator 5. Hereinafter, the data of the compensation coefficient is also referred to as compensation coefficient data. That is, in each prepared face image, the compensation coefficient data of each micro region or each pixel and the corresponding prepared capture distance is stored in the storage device 17 in an associated manner. That is, the image-capturing control apparatus 13 stores the compensation coefficient data of each prepared image, which is captured at a corresponding position set apart from the illuminator 5 by a corresponding prepared capture distance. Thus, when the image-capturing control apparatus 13 captures the currently captured face image and the distance from the illuminator 5 to the face is detected, the image-capturing control apparatus 13 compensates the luminance non-uniformity of the currently captured face image based on corresponding compensation coefficient data set for the corresponding prepared face image so that the luminance non-uniformity of the currently captured face image is equal to the luminance non-uniformity of the prepared reference image.

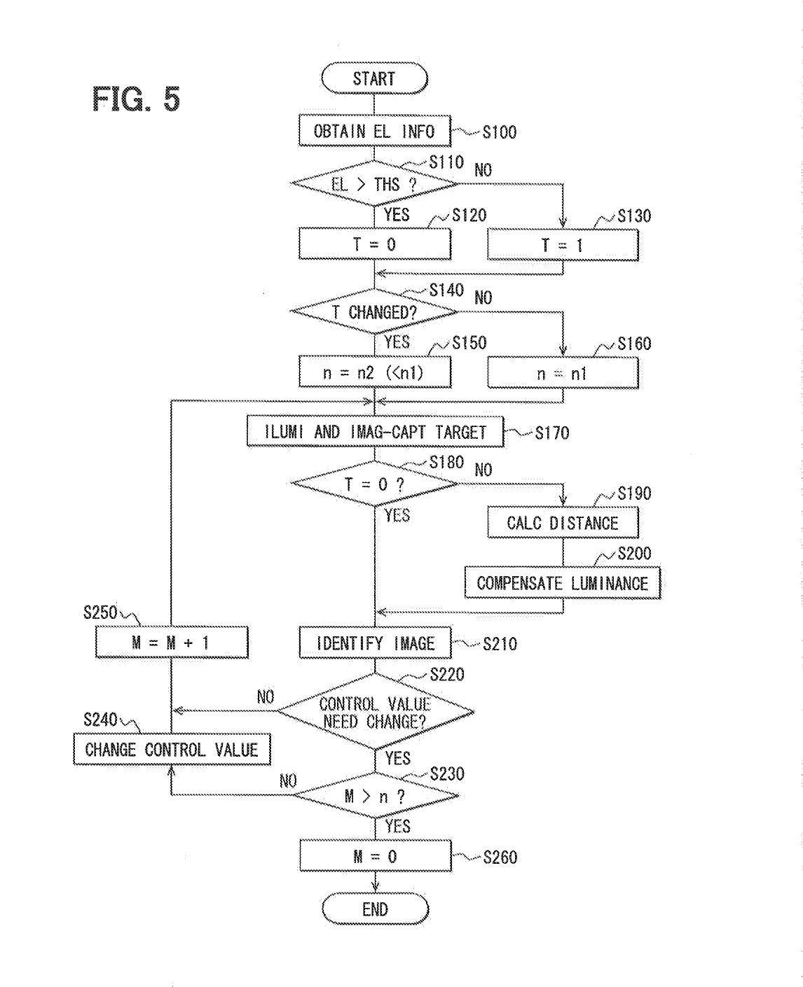

The following will describe a control process executed by the image-capturing control apparatus 13 with reference to FIG. 5. With execution of the control process, the image-capturing control apparatus 13 compensates the luminance non-uniformity of the currently captured face image to be equal to the luminance non-uniformity of the reference prepared image. Hereinafter, the luminance non-uniformity of the currently captured face image is also referred to as a current luminance non-uniformity, and the luminance non-uniformity of the reference prepared image is also referred to as a reference luminance non-uniformity. Further, a distance at which the prepared face image is captured is referred to as a prepared capture distance, and a distance at which the currently captured face image is captured is referred to as a current capture distance.

As shown in FIG. 5, at S100, the image-capturing control apparatus 13 obtains information of the environment light (EL). Specifically, the image-capturing control apparatus 13 detects the brightness of the surrounding area based on the signal transmitted from the illumination intensity sensor 7. Herein, the surrounding area refers to an area in a compartment of the vehicle, and the brightness of the surrounding area refers to an illumination degree, which indicates the intensity of the environment light.

At S110, the image-capturing control apparatus 13 determines whether the illumination degree is larger than a threshold illumination degree (THS). The threshold illumination degree is a lowest brightness under which the illumination by the near infrared light emitted from the illuminator 5 is not necessary. That is, the image-capturing control apparatus 13 determines whether the brightness of the surrounding area is bright enough so that the illumination by the near infrared light from the illuminator 5 is not necessary. When the image-capturing control apparatus 13 determines that the illumination degree is larger than the threshold illumination degree (S110: YES), the control process proceeds to S120.

At S120, the image-capturing control apparatus 13 sets a value of a flag T as zero. The flag T indicates the illumination degree of the environment light. When the illumination degree of the environment light is larger than the threshold illumination degree, the image-capturing control apparatus 13 sets the value of the flag T as zero. That is, when the intensity of the environment light is strong, such as in the daytime, the image-capturing control apparatus 13 sets the value of the flag T as zero. When the image-capturing control apparatus 13 determines that the illumination degree is equal to or smaller than the threshold illumination degree (S110: NO), the control process proceeds to S130. At S130, the image-capturing control apparatus 13 sets the value of the flag T as one. That is, when the intensity of the environment light is weak, such as in the nighttime, the image-capturing control apparatus 13 sets the value of the flag T as one.

At S140, the image-capturing control apparatus 13 determines whether the value of the flag T is changed from the latest value. When the image-capturing control apparatus 13 determines that the value of the flag T has been changed (S140: YES), the control process proceeds to S150.

At S150, the image-capturing control apparatus 13 sets a determination value n of a flag change as n2. Herein, the determination value n of the flag change indicates whether the value of the flag T is changed from the latest value. When the value of the flag T is changed, that is, the surrounding area is changed from a bright state to a dark state or from the dark state to the bright state, the determination value n of the flag change is set as n2. The determination value n2 is larger than a determination value n1, which will be described later.

When the image-capturing control apparatus 13 determines that the value of the flag T is not changed (S140: NO), the control process proceeds to S160. At S160, the image-capturing control apparatus 13 sets the determination value n of the flag change as n1. That is, the determination value n1 indicates that the surrounding area maintains bright or dark, that is, maintains the same state with a previous state.

At S170, the image-capturing control apparatus 13 controls the illuminator 5 to emit the light in order to illuminate the target based on a predetermined control value, and controls the camera 3 to capture images of the target. The predetermined control value of the illuminator 5 is set as an initial value when the image-capturing control apparatus 13 firstly starts the control process. In the present embodiment, the target is the face of the driver. At S180, the image-capturing control apparatus 13 determines whether the value of the flag T is equal to zero. That is, the image-capturing control apparatus 13 determines whether the surrounding area is in the bright state. When the image-capturing control apparatus 13 determines that the value of the flag T is equal to zero (S180: YES), the control process proceeds to S210. When the image-capturing control apparatus 13 determines that the value of the flag T is not equal to zero (S180: NO), the control process proceeds to S190.

At S190, the image-capturing control apparatus 13 calculates the current capture distance of the currently captured face image from the illuminator 5 to the face. At S190, since the surrounding area is in the dark state (T=1), the luminance non-uniformity is generated in the face image. The image-capturing control apparatus 13 calculates the current capture distance based on a change of the luminance at the predetermined point, such as the forehead center A shown in FIG. 4A, in the face image with respect to the distance. The process executed at S190 may operate as the calculation section 23.

At S200, the image-capturing control apparatus 13 compensates the luminance non-uniformity in the currently captured face image captured at S170. Specifically, first, the image-capturing control apparatus 13 obtains the compensation coefficient data of the corresponding prepared face image from the prepared relation data stored in the storage device 17 when the prepared capture distance of the corresponding prepared face image is equal to the current capture distance. As described above, the prepared relation data indicates the relationship between the prepared capture distance from the illuminator 5 to the face and the prepared luminance non-uniformity in the prepared face image. Further, the compensation coefficient data is used for compensating the luminance non-uniformity of the prepared face image captured at the corresponding prepared capture distance so that the prepared luminance non-uniformity is equal to the luminance non-uniformity of the reference prepared image. Then, the image-capturing control apparatus 13 compensates the currently captured face image so that the luminance non-uniformity of the currently captured face image is equal to the luminance non-uniformity of the reference prepared image based on the compensation coefficient data stored for the prepared face image. The process executed at S200 may operate as the obtaining section 31 and the compensating section 33 of the image-capturing control apparatus 13.

At S210, the image-capturing control apparatus 13 performs identification of features of the face based on the currently captured face image compensated as described above. Specifically, the image-capturing control apparatus 13 detects the gaze direction and the eye condition of the driver based on a well-known detection method as disclosed in JP 3316725 B2 and JP 2008-276328 A. As described above, the image-capturing control apparatus 13 detects the gaze direction based on the position of the pupil, and the eye condition is one of the open state and the closed state of the eye. Thus, the drowsy state of the driver can be detected based on the eye condition, and the inattentive state of the driver can be detected based on the gaze direction.

Further, the image-capturing control apparatus 13 determines whether the face image obtained from the camera 3 is appropriate for analysis. Specifically, the image-capturing control apparatus 13 determines whether the control values of the intensity of the near infrared light, the illumination timing, the exposure time, and the analog gain are appropriately set.

At S220, the image-capturing control apparatus 13 determines whether the control values need to be changed or adjusted in order to capture an improved face image. When the image-capturing control apparatus 13 determines that the control values need to be changed or adjusted (S220: YES), the control process proceeds to S230. When the image-capturing control apparatus 13 determines that the control values does not need to be changed or adjusted (S220: NO), the control process proceeds to S250.

The control values are set (changed or adjusted) in a feedback manner based on the face image already captured by the camera 3 in order to capture the improved face image. The control values may include, for example, the control value of the illumination timing, the control value of the exposure time, and the control value of the analog gain.

At S250, the image-capturing control apparatus 13 increments a value M of a counter by one (M=M+1), and returns to S170 so that S170 to S220 are repeatedly executed.

At S230, the image-capturing control apparatus 13 determines whether the value M of the counter is larger than the determination value n. When the image-capturing control apparatus 13 determines that the value M of the counter is larger than the determination value n (S230: YES), the control process proceeds to S260. When the image-capturing control apparatus 13 determines that the value M of the counter is smaller than the determination value n (S230: NO), the control process proceeds to S240.

At S240, the image-capturing control apparatus 13 changes the control values and proceeds to S250. Then, as described above, the image-capturing control apparatus 13 increments the value M of the counter by one (M=M+1), and returns to S170 so that S170 to S220 are repeatedly executed. At S260, the image-capturing control apparatus 13 clears the value M of the counter (M=0), and ends the control process. The control process shown in FIG. 5 is repeatedly executed by the image-capturing control apparatus 13 while the image-capturing control apparatus 13 is in an activate state.

The image-capturing control apparatus 13 according to the present embodiment provides the following benefits.

In the present embodiment, the image-capturing control apparatus 13 obtains information of the luminance non-uniformity of the prepared face image from the prepared relation data stored in the storage device 17 when the prepared capture distance of the prepared face image is equal to the current capture distance. Then, the image-capturing control apparatus 13 compensates the luminance non-uniformity of currently captured face image based on the information of the luminance non-uniformity of the prepared face image.

As described above, when the distance from the illuminator 5 to the camera 3 changes, the luminance non-uniformity in the face image changes. In the present embodiment, the prepared relation data indicative of the prepared luminance non-uniformity and the prepared capture distance are previously stored in the storage device 17. When the current capture distance is equal to the one prepared capture distance of one of the prepared relation data, the image-capturing control apparatus 13 compensates the current luminance-uniformity based on the information of the luminance non-uniformity of the prepared face image. Thus, a change of the luminance non-uniformity in the currently captured face image, which changes with the current capture distance, is restricted. Accordingly, an accuracy of the identifying the face (face orientation and gaze direction) of the driver is increased.

The luminance non-uniformity in the face image indicates the variation of the luminance of the face image on the surface of the face. The variation of the luminance is caused by the uneven surface of face. Herein, the luminance non-uniformity of the face image is equal to a luminance distribution in the face image. The luminance distribution in the face image may also be viewed as a change of the luminance distribution from a luminance distribution in an image of a target having a flat surface.

In the present embodiment, the storage device 17, which is provided by multiple types of memory devices, stores the prepared relation data of the prepared face images captured at predetermined positions. The predetermined positions are apart from one another by the predetermined distance interval.

Further, the calculation section 23 calculates the distance at which the face is captured based on the luminance or pixel value at the predetermined point in the face image. For example, when the light emitted from the illuminator 5 is illuminated on the face of the driver at a predetermined intensity at the same distance, the luminance at the predetermined point in the face image maintains the same. That is, conditions, such as the intensity of the light from the illuminator 5, other than the distance are the same, the luminance at the predetermined point in the face image changes with the distance. Thus, the distance may be detected and calculated based on the change of the luminance at the predetermined point in the face image.

Specifically, the image-capturing control apparatus 13 stores the prepared luminance non-uniformity of the prepared face image in relation with the reference luminance non-uniformity of the reference prepared image. Then, the image-capturing control apparatus 13 compensates the current luminance non-uniformity of the currently captured face image to be equal to the reference luminance non-uniformity of the reference prepared image.

With above-described configuration, an identification accuracy is substantially increased. Thus, the gaze direction and the eye condition are detected with a high accuracy.

Further, the image-capturing control apparatus 13 compensates the current luminance non-uniformity as described above when the intensity of the environment light is weak, that is, equal to or lower than the threshold illumination degree. Thus, a difficulty in identification of the currently captured face image caused by the luminance non-uniformity is restricted.

In the present embodiment, the image-capturing control apparatus 13 may compensate the current luminance non-uniformity so that the variation of the current luminance non-uniformity, which is caused by the current capture distance, is reduced.

When the image-capturing control apparatus 13 compensates the current luminance non-uniformity so that the variation of the current luminance non-uniformity is reduced, identification based on the currently captured face image captured at any distance is performed with a high accuracy.

In the present embodiment, the storage device stores the reference prepared image captured at a predetermined distance and the reference prepared luminance non-uniformity. Then, the image-capturing control apparatus 13 compensates the current luminance non-uniformity so that the current luminance non-uniformity approaches the reference luminance non-uniformity. Alternatively, the image-capturing control apparatus 13 may compensate the current luminance non-uniformity so that the current luminance non-uniformity is equal to the reference luminance non-uniformity.

With above-described configuration, the currently captured face image is compensated so that the current luminance non-uniformity is equal to the reference luminance non-uniformity regardless of the current capture distance. Thus, the current luminance non-uniformity has a constant value. Thus, the identification accuracy based on the currently captured face image captured at any distance is substantially increased.

In the present embodiment, each of the prepared face images is divided into a plurality of prepared micro regions (or pixels). With respect to each of the prepared face images, the storage device 17 stores luminance related information, which includes a compensation coefficient, for each of the prepared micro regions. With respect to each of the prepared face images, the compensation coefficient is set so that a prepared luminance of each of the prepared micro regions is converted to a reference luminance of corresponding one of the prepared micro regions included in the reference prepared image.

In the present embodiment, the relation data may include information of the luminance of each micro region with respect to each prepared face image. Herein, the information of the luminance of each micro region includes the compensation coefficient based on which the prepared luminance non-uniformity in one of the prepared face images is converted to the reference luminance non-uniformity. Thus, the luminance non-uniformity in the currently captured face image can be compensated so that the current luminance non-uniformity approaches the reference luminance non-uniformity.

The compensation coefficient may be provided by the conversion factor which enables the luminance of each micro region in currently captured face image approaches the luminance of each micro region in the reference prepared image.

Further, in the present embodiment, the image-capturing control apparatus 13 compensates the currently captured face image when the intensity of the environment light is equal to or lower than the threshold illumination degree, which is also referred to as a threshold value.

When the intensity of the environment light is weak, such as in the nighttime, the capturing of the face image is performed under the illumination of the light, which is emitted from the illuminator. Thus, the luminance non-uniformity is highly possibly generated in the currently captured face image. Thus, the luminance non-uniformity is restricted effectively when the compensation is performed by the image-capturing control apparatus 13.

Further, in the present embodiment, the target captured by the camera 3 is the face of the driver. Since the surface of the face is not flat, the luminance non-uniformity is highly possibly generated in the face image. Thus, the luminance non-uniformity is restricted effectively when the compensation is performed when the target captured by the camera is the face of the driver.

According to the present embodiment, a program product may execute instructions to perform the processes executed at S200, which corresponds to the obtaining section 31 and the compensating section 33. That is, the functions of the image-capturing control apparatus 13 may be achieved by processes executed by a program product.

The above-described program product may be stored in a non-transitory computer readable storage medium, such as a floppy disk (FD), a magneto-optical disk (MO), a DVD-ROM, a CD-ROM, a hard disk and the like. The program product may be read out from the computer readable storage medium and stored in an computer to be executed when needed. Further, a read only memory (ROM) or a backup random access memory (RAM) may store the program product as the computer readable storage medium. Then the ROM and the RAM may be built in the computer to execute the instruction stored in the ROM and the RAM.

### Other Embodiments

In the foregoing embodiment, the image-capturing control performed by the image-capturing control apparatus 13 is achieved by a software configuration. Accordingly, a program product executing instructions to perform the image-capturing control is within a scope of the present disclosure.

In the foregoing embodiment, the first distance from the illuminator 5 to the face of the driver is used as distance information of the prepared relation data. Further, the second distance from the camera 3 to the face of the driver may be used as the distance information of the prepared relation data.

The luminance non-uniformity of the currently captured face image changes with a change of a sum of the first distance and the second distance. Thus, the sum of the first distance and the second distance may also be used as the distance information of the prepared relation data.

In the foregoing embodiment, the image-capturing control apparatus 13 is used to detect the drowsy state and the inattentive state of the driver. Further, the image-capturing control apparatus 13 may also be used for an individual identification.

In the foregoing embodiment, the image-capturing control apparatus 13 determines the intensity of the environment light based on the signals transmitted from the illumination intensity sensor 7 and the clock IC 29. Further, the image-capturing control apparatus 13 may determine the intensity of the environment light based on the luminance of the currently captured face image, which is captured by the camera 3 with the illuminator 5 activated (or deactivated).

Further, the image-capturing control apparatus 13 may determine that the intensity of the environment is weak when the navigation device 9 determines that the vehicle is passing through a tunnel.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An image-capturing control apparatus, which controls a light source to emit light including near infrared light toward a target and controls an image-capturing device to capture an image of the target, the image-capturing control apparatus comprising:
a storage device that stores a plurality of prepared relation data of a plurality of prepared images of the target, each of the prepared relation data indicating a relationship between information of a prepared luminance non-uniformity in corresponding one of the prepared images and a prepared capture distance at which the corresponding one of the prepared images is captured;
a calculation section that calculates a current capture distance when the image-capturing device captures a current image of the target;
an obtaining section that obtains information of a target luminance non-uniformity from one of the prepared relation data when the current capture distance is equal to the prepared capture distance of the one of the prepared relation data, the target luminance non-uniformity being equal to the prepared luminance non-uniformity of the one of the prepared relation data; and
a compensating section that compensates a current luminance non-uniformity in the current image of the target based on the information of the target luminance non-uniformity.

2. The image-capturing control apparatus according to claim 1,
wherein a distance from the light source to the target is referred to as a first distance, and a distance from the image-capturing device to the target is referred to as a second distance, and
wherein each of the prepared capture distance and the current capture distance is defined by at least one of the first distance and the second distance.

3. The image-capturing control apparatus according to claim 1,
wherein the compensating section compensates the current luminance non-uniformity so that a variation of the current luminance non-uniformity, which is caused by the current capture distance, is reduced.

4. The image-capturing control apparatus according to claim 1,
wherein one of the prepared images captured at a predetermined distance is referred to as a reference prepared image, and the luminance non-uniformity in the reference prepared image is referred to as a reference luminance non-uniformity, and
wherein the compensating section compensates the current luminance non-uniformity so that the current luminance non-uniformity approaches the reference luminance non-uniformity.

5. The image-capturing control apparatus according to claim 4,
wherein each of the prepared images of the target is divided into a plurality of prepared micro regions,
wherein, with respect to each of the prepared images, the storage device stores luminance related information, which includes a compensation coefficient, for each of the prepared micro regions, and
wherein, with respect to each of the prepared images, the compensation coefficient is set so that a prepared luminance of each of the prepared micro regions is converted to a reference luminance of corresponding one of the prepared micro regions included in the reference prepared image.

6. The image-capturing control apparatus according to claim 1,
wherein the compensating section compensates the current luminance non-uniformity when an intensity of environment light is equal to or lower than a threshold value.

7. The image-capturing control apparatus according to claim 1,
wherein the current image of the target is an image of a face of a driver.

8. A control method of capturing an image of a target comprising:
storing a plurality of prepared relation data of a plurality of prepared images of the target, each of the prepared relation data indicating a relationship between a prepared luminance non-uniformity in corresponding one of the prepared images and a prepared capture distance at which the corresponding one of the prepared images is captured;
capturing a current image of the target;
detecting a current capture distance at which the current image of the target is captured;
obtaining a target luminance non-uniformity from one of the prepared relation data when the current capture distance is equal to the prepared capture distance of the one of the prepared relation data, the target luminance non-uniformity being the luminance non-uniformity of the one of the prepared relation data; and
compensating a current luminance non-uniformity in the current image of the target based on the target luminance non-uniformity.

9. A program product stored in a non-transitory computer readable storage medium comprising instructions to be executed by a computer, the instructions for implementing
the obtaining of the target luminance non-uniformity and the compensating of the current luminance non-uniformity in the current image of the target according to claim 8.
